(19) United States
(12) Patent Application Publication
(10) Pub. No.: US 2006/0218249 A1
(43) Pub. Date: Sep. 28, 2006

(54) AV transmission system, server device of AV transmission system, and client device

(75) Inventor: Takafumi Nakase, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/386,689

(22) Filed: Mar. 23, 2006

(30) Foreign Application Priority Data
Mar. 25, 2005 (JP) 2005-087783

(51) Int. Cl. G06F 15/16

(52) U.S. Cl. 709/219

(57) ABSTRACT

An AV transmission system is structured so that: information of specialized function of a connected AV apparatus is sent from the AV apparatus to a server device and from the server device to a client device, and in case a function menu key is operated at the client device side, functional performances of the AV apparatus corresponding to a plurality of function keys are displayed, and in case the function key is operated, operation information of the function key is sent from the client device to the server device, a command code of the specialized function corresponding to the function key is extracted at the server device, and the command code is sent from the server device to the AV apparatus.

### BACKGROUND OF THE INVENTION

1. Field of the Invention

The present invention relates to an AV transmission system, a server device of AV transmission system, and a client device, in which an image/audio data is received from an externally connected AV apparatus and transmitted from the server device as a streaming data, the streaming data is received at the client device and demodulated into an image signal and a audio signal, and then outputted.

2. Description of the Related Art

In recent years, an AV transmission system which connects an AV apparatus to a server device, sends streaming data of image/audio through wireless transfer to a client device from the server device, and enables video watching at the client device side has been developed.

Conventionally, concerning a home network in which a plurality of AV apparatuses are network-connected, a technique for operation by assigning function of each or AV apparatuses dynamically to a remote control key (patent document 1) and a technique to display a list of function of the entire system structure and the connected AV apparatuses (patent document 2) are suggested.

In addition, concerning a wireless AV system in which a plurality of AV apparatuses are connected with each other through radio transmission, a technique to detect and display output a rough positional relationship of each of the AV apparatuses (patent document 3). Further, concerning a system in which an external device is connected to a cellular phone, and a wireless communication between the external device and a server is enabled through the cellular phone, a technique to simplify a connecting operation of the external device and the server has been developed (patent document 4).

Patent document 1 : Tokukaihei 2001-128025

Patent document 2 : Tokukaihei 2001-337763

Patent document 3 : Tokukaihei 2004-336732

Patent document 4 : Tokukaihei 2003-216309

### SUMMARY OF THE INVENTION

Concerning AV apparatus, there are various kinds of apparatuses such as a digital television tuner, a personal video recorder (PVR), a DVD video player, and the like. Therefore, functional performance of each AV apparatus becomes extremely versatile. That is, concerning an AV apparatus of a recording and replaying type, basic functional performances such as replay, stop, forward, rewind, and the like are in common, however, there are various kinds of specialized functions that are provided only to a particular model or type of the AV apparatus, such as extension of recording time, changing recording rate, turning off the switch after end of recording, and the like.

In addition, it is anticipated that AV apparatus with a new specialized function that cannot be identified at present will be newly developed.

In the AV transmission system, it is supposed that a server device and a client device are installed in a different room. In such case, since the AV apparatus is installed in a room different from the user, direct operation of the AV apparatus by using an infrared remote control, which is originally equipped to the AV apparatus, cannot be done. Therefore, the structure of the system would comprise of inputting an operation command to the client device by using a remote control of the client device, and operating the AV apparatus by transmitting the information from the client device to the server device.

Concerning an AV transmission system using a number of AV apparatuses connected externally, since basic functional performances are in common, these functional performances can be assigned to a remote control key of the client device in advance.

However, as for detailed functions and specialized functions that differ among each of AV apparatuses, in case a lot of models and types of AV apparatuses are intended, the number of such functions will become enormous, and assignment to remote control key of the client device in advance becomes difficult. In addition, it is impossible to assign in advance a specialized function of an AV apparatus, which is to be newly developed, to the remote control key.

Regarding these reasons, a technique disclosed in the above mentioned patent document 1 can be applied to basic functional operations that are in common with various kinds of AV apparatuses, however, cannot be applied to specialized functions that cannot be identified at present.

An object of the present invention is, concerning an AV transmission system in which image/audio from an AV apparatus is transferred from a server device and enables video watching at the client device side, to provide an AV transmission system that can obtain comprehensively by an easy operation, even unspecified functional performance provided in the externally connected AV apparatus from the client device and execute such unspecified functional performance.

In order to achieve the above mentioned object, an AV transmission system comprises a server device to receive data or signal of image and audio from an externally connected AV apparatus and transfer image data and audio data according to the data or signal continuously; further comprising: a function information obtaining section to obtain a function information indicating information of a functional performances actuated by external operation from the externally connected AV apparatus and a command code to execute the functional performances; a command sending section to send a command to the externally connected AV apparatus and actuate the functional performances; and a first communication section to conduct data communication with a client device, and the client device to receive the image data and audio data from the server device and to demodulate the image data and audio data into image signal and audio signal that can be display outputted and audio outputted; further comprising: an operation inputting section to input an operation command from exterior; a character display inserting section to insert a signal of a character display in the image signal; and a second communication section to conduct data communication with the server device; wherein: information of the functional performances is sent from the server device to the client device through the second communication section; assignment information of predetermined operation command which can be inputted from the operation inputting section corresponding to the functional performance of the AV apparatus is outputted within insertion into the image signal by the character inserting section, in case a first operation command is inputted from the operation inputting section; and information is sent from the client device to the server device through the second communication section, and a command to actuate a corresponding functional performance is sent from the server device to the externally connected AV apparatus, in case the predetermined operation command is inputted.

According to the aforementioned measures, even in case where the externally connected AV apparatus has a number of specialized functions that cannot be identified in advance, such specialized functions can be actuated through operation of the specialized functions from the client device side, by correlating the specialized functions with operation command in an ex-post manner. In addition, since an assignment relationship of operation command corresponding to the specialized function can be displayed on screen, a user can easily figure which operation command is assigned to which specialized function, and conduct operation by observing the screen.

Preferably, the server device is provided with a storing section to store a key assignment information which describes an assignment relationship of the predetermined operation command corresponding to the functional performance of the AV apparatus; and input information of the predetermined operation command is sent from the client device to the server device through the first communication section, and functional performance of an AV apparatus corresponding to the operation command is determined according to the input information of the operation command and the key assignment information in case the predetermined operation command is inputted through the operation inputting section.

The specialized function at the AV apparatus side is not specified. Meanwhile, operation command itself at the client device is specified beforehand. Therefore, as described in the aforementioned structure, by sending the input information of the operation command from the client device to the server device and then sending a command corresponding to the input information of the operation command from the server device to the AV apparatus, a communication contents between the server device and the client device during function operation can be set beforehand, thus enables to simplify the communication form between the server device and the client device.

More preferably, the operation inputting section is a remote control provided with a plurality of operation keys; and the remote control is provided with a function menu key that can input the first operation command in one operation, and a plurality of function keys that can input the predetermined operation command in one operation.

By the aforementioned structure, within a simple operation, the user can affirm an assignment relationship of the functional performances of the AV apparatus and the function key, and actuate the desired functional performance assigned to the function key by a simple operation.

As described above, even in case where the AV apparatus has a number of specialized functions that cannot be identified in advance, such specialized functions can be actuated through operation of the specialized functions from the client device side, by correlating the specialized functions with operation command in an ex-post manner. In addition, since an assignment relationship of operation command corresponding and the specialized function can be display outputted, a user can easily find out which operation command is assigned to which specialized function by observing the screen.

In addition, by storing an assignment relationship of the operation command and the functional performance of the AV apparatus in the server device, and sending an information of operation command from the client device to the server device but not sending an information of functional performance from the client device to the server device, advantageous effect in that communication from between the server device and the client device can be simplified can be obtained.

In addition, by providing a plurality of function keys that are assigned to the functional performance of the AV apparatus and a function menu key that display an assignment relationship of the functional performance and the function key, to a remote control at the client device side, advantageous effect in that a user can easily operate various kinds of functional performance of the AV apparatus can be obtained.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a system structure diagram showing a usage pattern of an AV transmission system of the embodiment of the present invention;

FIG. 2 is a block diagram showing an internal structure of a server device and a client device of the AV transmission system;

FIG. 3 is a performance chart to explain a performance in case of connecting an AV apparatus to a server device and operating the AV apparatus at a client device side;

FIG. 4 is a view showing specialized key information sent from the AV apparatus to the server device;

FIG. 5 is a data table showing specialized key assignment information generated at the server device; and

FIG. 6 is a data table showing function key assignment information sent to and stored in the client device.

### DETAILED DESCRIPTION OF THE PREFERRED EMBODIMENT

An embodiment of the present invention will be described with reference to figures.

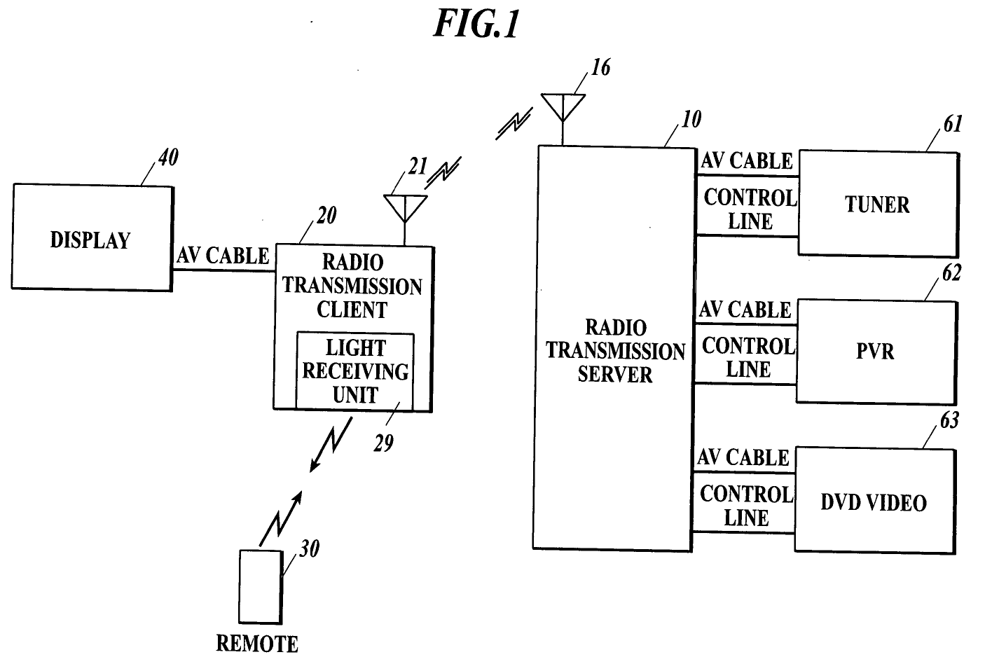

FIG. 1 is a system structure diagram showing a usage pattern of an AV transmission system of the embodiment of the present invention.

An AV transmission system of the present embodiment includes a server device 10 to receive an image/audio data or signal from an externally connected AV apparatus and to send streaming data of image/audio through wireless transfer, a client device 20 to receive the streaming data from the server device 10 and to output image signal and audio signal to television receiver 40 and the like that are externally connected, and the like.

To the server device 10, various kinds of AV apparatuses such as digital television tuner 61, PVR (personal video recorder) 62 such as hard disc recorder, DVD video recorder 63, and the like are connected. These connections are conducted by, for example, a cable connection to send image audio using D connector or S connector and the like, and a connection with exclusive control line (function information obtaining section) that can send and receive commands and inquire function information. Alternatively, a connection through IEEE1394 interface can achieve a similar function.

As for functional performance equipped to each AV apparatuses, there are a general function which is commonly equipped among a plurality of models, and a specialized function which is equipped or not equipped depending on the model and type. As for the general function, for example, a moving operation of a cursor, in case of television tuner type apparatus, a channel changing operation by addressing channel numbers of channel 1 through channel 12, and a channel changing operation by adjusting the receiving channel one by one, in case of a recording and replaying type apparatus, various kinds of operation functions such as replay, record, stop, pause, forward, rewind, and the like can be mentioned.

As for the specialized function, for example, in case of the PVR 62, various kinds of functions such as extension of recording time, changing recording rate, and turning off the switch after end of recording, in case of the digital television tuner 61, various kinds of operation functions such as displaying program information, switching between satellite broadcasting and terrestrial digital broadcasting, and inputting four color keys of red, blue, yellow, green, can be mentioned.

The client device 20 and the television receiver 40 are connected through an AV cable such as D connector cable and S connector cable, and only signals of image/audio are mainly sent from the client device 20 to the television receiver 40.

The server device 10 and the client device 20 can each be set in a different room, and in case of such settings, a user who conducts video watching in a room in which the client device 20 is set cannot directly conduct operation of AV apparatuses 61-63 that are set in a room in which the server device 10 is set. Therefore, remote control 30 of the client device 20 is used to conduct operation indirectly through the client device 20 and the server device 10.

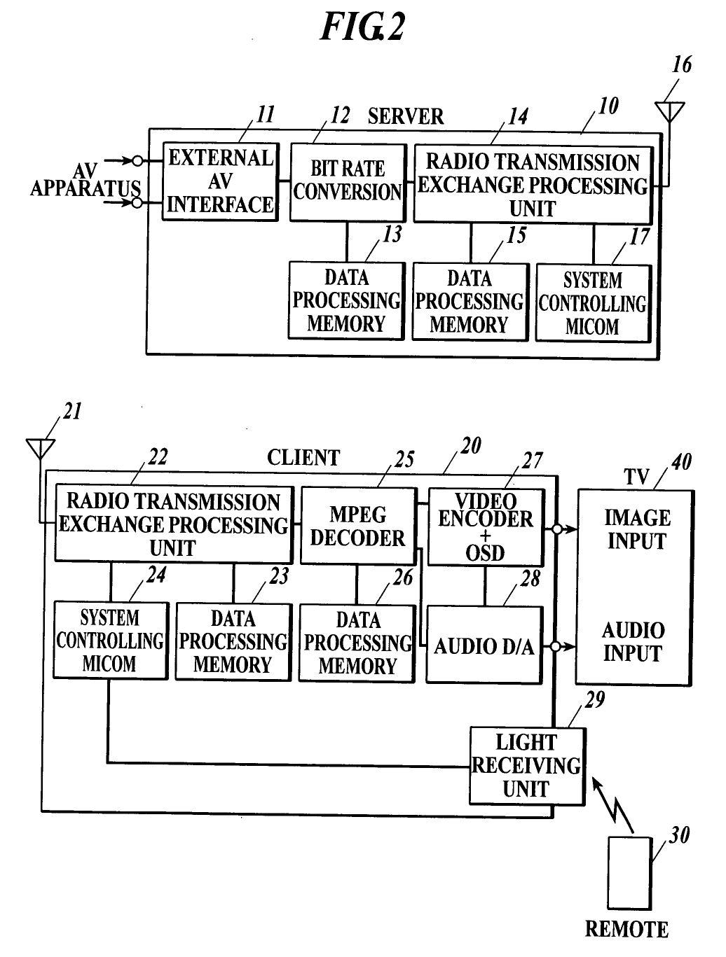

FIG. 2 is a block diagram showing an internal structure of the server device 10 and the client device 20.

The server device 10 comprises an AV interface 11 to take in image/audio data and signal from the external AV apparatuses 61-63 as well as exchange controlling signals, a bit rate conversion circuit 12 which is also called transcoder to convert a bit rate of the image/audio data, a data processing memory 13 used by the bit rate conversion circuit 12, a radio transmission exchange processing unit 14 as a sending and receiving section to send image/audio data converted into a form for wireless transfer and exchange commands and data, a data processing memory 15 used by the radio transmission exchange processing unit 14, an antenna 16 to send and receive radio transmission signal, a system controlling microcomputer (hereinafter referred to as controlling micom 17) 17 to control the server device 10 entirely, and the like.

The above-mentioned AV interface 11, in case of connecting an AV apparatus that can only output analog image/audio, needs to have a function to conduct digital compression of the image/audio signals. Accordingly, the analog image/audio signals are changed into MPEG (Motion Picture Experts Group) data for example, and are taken in.

The client device 20 comprises an antenna 21 to send and receive radio transmission, a radio transmission exchange processing unit 22 as a sending and receiving section to receive transmission data from the server device 10, decompress the image/audio data, and exchange commands and data, a data processing memory 23 used by the radio transmission exchange processing unit 22, an MPEG decoder 25 to decode image/audio data that are compressed in an MPEG form for example, a data processing memory 26 used by the MPEG decoder 25, a video encoder 27 to demodulate the decoded image data into an image signal that can be inputted to the television receiver 40, an audio encoder 28 to demodulate the decoded audio data into an analog audio signal, a remote (remote control) 30 as an operation inputting section which is provided with a plurality of operation keys and receives operation command from the external, a light receiving unit 29 to input a signal from the remote 30, a system controlling microcomputer (hereinafter referred to as controlling micom 24) 24 to control the client device 20 entirely, and the like.

The video encoder 27 is provided with an OSD (On Screen Display) function as a character displaying section which inserts a signal to display characters such as letters and symbols into the image signals, according to the instruction from the controlling micom 24.

The remote 30, other than the channel keys of channels 1-12, key to up-down the channel, operation keys of general functions such as replay, stop, forward, rewind, record, is provided with a plurality of function keys (a key to input predetermined operation command) that are assigned with various kinds of functions, and a function menu key (a key to input a first operation command) to display a content of the function key.

In addition, the controlling micom 17 of the server device 10 and the controlling micom 24 of the client device 20 are each provided with a nonvolatile memory that store control programs and control data, a RAM (Random Access Memory) that provides working memory area, and a CPU (Central Processing Unit) to execute the control program.

Next, performance of the aforementioned AV transmission system is described.

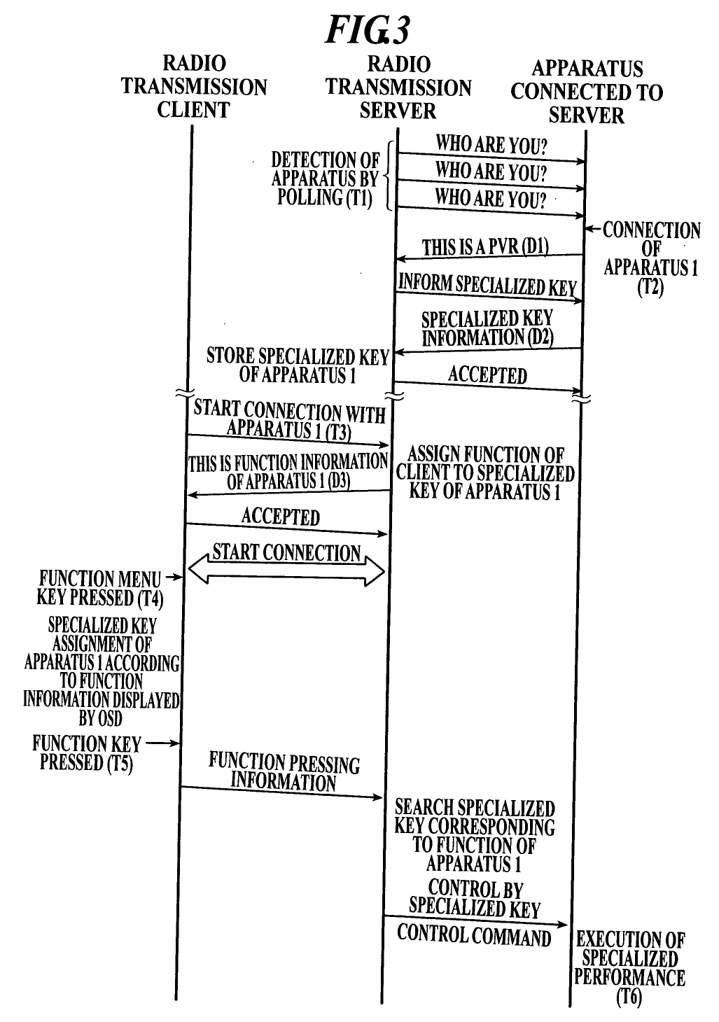

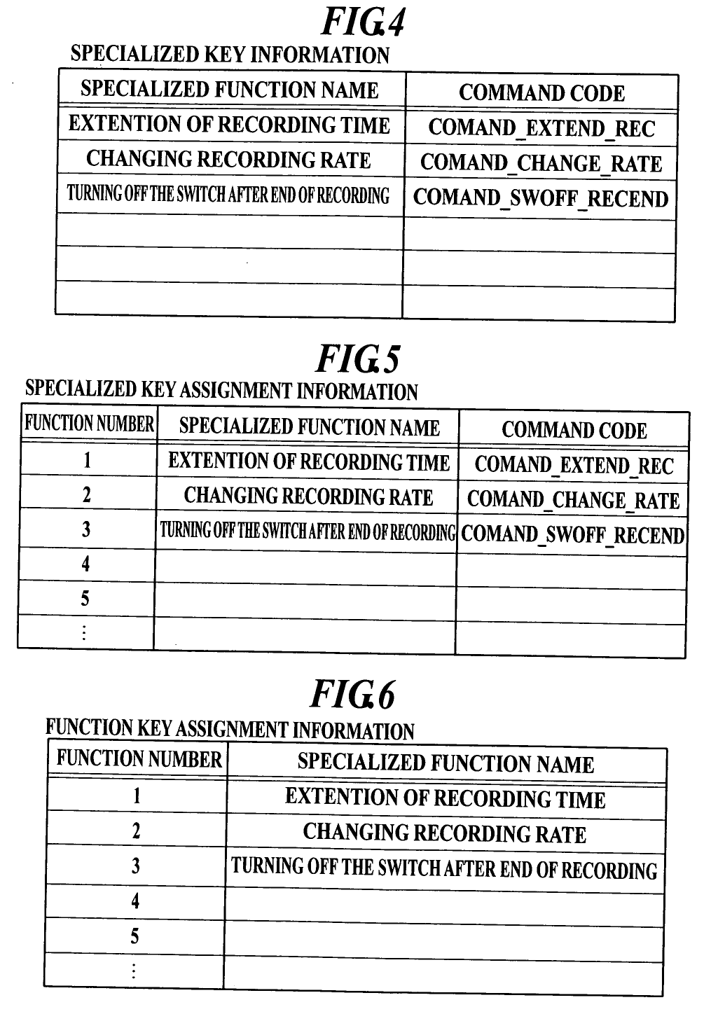

FIG. 3 is a performance chart to explain a performance in case of connecting the AV apparatus to the server device and operating the AV apparatus at a client device side and FIGS. 4-6 are each a data table showing a specialized key information sent from the AV apparatus, a specialized key assignment information stored at the server device, and a data table showing function key assignment information stored in the client device.

As shown in FIG. 3, at the server device 10, by polling through a control line, connection of a new apparatus is checked periodically (T1). Here, in case a new AV apparatus is connected (T2), a data (D1) to distinguish a connected AV apparatus is sent from the AV apparatus corresponding to the polling of the server device 10, to the server device 10, and the connected apparatus becomes acknowledged at the server device 10.

When the connection becomes acknowledged, an inquiry for specialized key information is sent from the server device 10 to the AV apparatus, and specialized key information (D2) is sent from the AV apparatus to the server device 10. Then, at the server device 10, this specialized key information is stored in the nonvolatile memory with correspondence to distinguishing information of the AV apparatus. Accordingly, response that connection has been accepted is given from the server device 10, and the connection of the server device 10 and AV apparatus is achieved.

Here, the specialized key information is information on functional performance of the AV apparatus which can be operated from the client device 20 side, among the functional performance of the AV apparatus. Particularly, it is mainly information on operation function that is in correspondence with the specialized key (function key) of the remote equipped to the AV apparatus. As shown in FIG. 4, specialized key information is, for example, structured by aligning name information of the aforementioned specialized function, command code to call up the specialized function, and the like consecutively.

As shown in timing T3 of FIG. 3, when a user operates a remote 30 of the client device 20 to select one of a plurality of AV apparatuses connected to the server device 10 and gives out a connecting command, first of all, specialized key information of an AV apparatus subject to the connection demand is read out at the server device 10. Then a data processing is conducted to assign a plurality of specialized function included in the specialized key information to the function key of the remote 30 of the client device 20. This assignment is, for example, conducted by assigning the specialized function in order to the function key in numerical order, and as a result, a data table of specialized key assignment information (key assignment information stored at the server device 10 side) as shown in FIG. 5 is generated.

Subsequently, function key assignment information (D3) of the AV apparatus subject to the connection demand is sent from the server device 10 to the client device 20. This function key assignment information is, as shown in FIG. 6, a data which extracts only function number and name data of the specialized function from the data table of the aforementioned specialized key assignment information (key assignment information stored at the client device 20 side). This function key assignment information is stored in the nonvolatile memory or RAM of the client device 20.

Subsequently, an acceptance response that indicates completion of connection preparation is sent from the client device 20 to the server device 10, and it becomes possible to operate one AV apparatus from the client device 20 through the server device 10.

In this state, in case a user conducts operation of general function such as replay and stop, by operating a replay key and stop key provided on the remote 30, operation command is sent from the client device 20 to the server device 10, and a command code is sent from the server device 10 to the AV apparatus, thus performance of the AV apparatus such as replay and stop is achieved. Here, operation command sent from the client device 20 to the server device 10 and the command code sent from the server device 10 to the AV apparatus are preinstalled in the client device 20 and the server device 10 at the time of shipment of the devices. Since these signals and commands are related to operation of general function that are in common with a plurality of models and types of AV apparatus, it can be set as a signal or a command code that are in common with the client device 20, the server device 10, and each of the AV apparatuses, beforehand.

Meanwhile, in case of conducting operation of specialized function such as extension of recording time and changing recording rate, first of all, a user operates a function menu key of the remote 30 (T4). Then, at the client device 20, a function key assignment information which is stored internally is read out, and accordingly, a name information of specialized function of the connected AV apparatus which is assigned to each function key is outputted to a display of a television receiver 40, inserted into an image signal by an OSD function of a video encoder 27.

This enables the user to confirm which function key is assigned to which specialized function, therefore, by operating a function key which is assigned with the desired specialized function next (T5), an operation command of the function key is sent to the server device 10 sequentially. Subsequently, at the server device 10, a command code of specialized function corresponding to the function key is retrieved from a data table of the specialized key assignment information. Thus, by this command code, the specialized function desired by the user is executed at the AV apparatus (T6).

As described above, according to the AV transmission system of the present embodiment, even in case where a plurality of AV apparatuses 61-63 connected to the server device 10 have a number of specialized functions that cannot be identified in advance, advantageous effect in that such specialized functions can be executed through operation of the function key from the client device 20 side, by correlating the specialized functions with the plurality of function keys of the client device 20 in an ex-post manner, can be obtained.

Additionally, by storing assignment information of the function key and the command code of the specialized function in the server device 10, and by adopting a structure which in case of executing the specialized function, sends only the operation command of the function key from the client device 20 to the server device 10 and does not send information on the specialized function, advantageous effect in that communication between the server device 10 and the client device 20 during the operation of the AV apparatus can be simplified, can be obtained.

Additionally, since a plurality of function keys that can read out the specialized function of the AV apparatus within one operation, and a function menu key to display the content of the function key within one operation are provided to the remote 30 of the client device 20, advantageous effect in that a user can easily operate various kinds of specialized functions of each AV apparatus, can be achieved.

Here, the present invention is not limited to the aforementioned embodiment, and various modifications can be applied. For example, function menu key and function key is provided to the remote in the embodiment, however, the same operation can be made executed by selecting an item in a menu display, for example. Additionally, in the present embodiment, specialized function was separated from the general function, and only the specialized function was assigned dynamically to function key, however, general function can also be assigned dynamically to each key of the remote to be performed.

Otherwise, types of AV apparatus connected to the server device and content of functional performance assigned dynamically to remote key can also be modified arbitrarily as long as it does not deviate the intent of the present invention.

The entire disclosure of Japanese Patent Application No. Tokugan 2005-087783 filed on Mar. 15, 2005 including specification, claims, drawings and summary are incorporated herein by reference in its entirety.

1. An AV transmission system comprising:
a server device to receive data or signal of image and audio from an AV apparatus externally connected and transfer image data and audio data according to the data or signal continuously; further comprising:
a function information obtaining section to obtain a function information indicating information of functional performances actuated by external operation from the AV apparatus externally connected and a command code to execute the functional performances,
a command sending section to send commands to the AV apparatus externally connected and actuate the functional performances,
a first communication section to conduct data communication with a client device, and
a storing section to store a key assignment information which describes an assignment relationship of a plurality of function keys of the client device corresponding to the functional performances of the AV apparatus; and
the client device to receive the image data and the audio data from the server device and demodulate the image data and the audio data into image signal and audio signal that can be display outputted and audio outputted; further comprising:
a character display inserting section to insert a signal of a character display in the image signal,
a second communication section to conduct data communication with the server device, and
a remote control to input an operation command from exterior, provided with a plurality of operation keys including the plurality of function keys and function menu key; wherein:
information of the functional performances is sent from the server device to the client device through fist and second communication sections;
assignment information of the plurality of function keys corresponding to the functional performances is outputted within insertion into the image signal by the character display inserting section, in case the function menu key is operated; and
operation information of the function key is sent from the client device to the server device through the first and second communication sections, one of the functional performances of the AV apparatus corresponding to operated function key is determined according to the operation information and the key assignment information, and one of the commands to actuate the one of the functional performances is sent from the server device to the AV apparatus, in case the function key is operated.

2. An AV transmission system comprising:
a server device to receive data or signal of image and audio from an AV apparatus externally connected and transfer image data and audio data according to the data or signal continuously; further comprising:
a function information obtaining section to obtain a function information indicating information of functional performances actuated by external operation from the externally connected AV apparatus and a command code to execute the functional performances,
a command sending section to send commands to the AV apparatus externally connected and actuate the functional performances, and
a first communication section to conduct data communication with a client device; and
the client device to receive the image data and the audio data from the server device and demodulate the image data and the audio data into image signal and audio signal that can be display outputted and audio outputted; further comprising:
an operation inputting section to input an operation command from exterior,
a character display inserting section to insert a signal of a character display in the image signal, and
a second communication section to conduct data communication with the server device; wherein:
information of the functional performances is sent from the server device to the client device through first and second communication sections;
assignment information of predetermined operation command which can be inputted from the operation inputting section corresponding to the functional performances of the AV apparatus is outputted within insertion into the image signal by the character inserting section, in case a first operation command is inputted from the operation inputting section; and
information is sent from the client device to the server device through the first and second communication sections, and one or the commands corresponding to actuate one of the functional performances is sent from the server device to the AV apparatus externally connected, in case the predetermined operation command is inputted.

3. The AV transmission system as claimed in claim 2, wherein
the server device is provided with a storing section to store a key assignment information which describes an assignment relationship of the predetermined operation command corresponding to the functional performances of the AV apparatus; and
input information of the predetermined operation command is sent from the client device to the server device, and the one of the functional performances of the AV apparatus corresponding to the operation command is determined according to the input information of the operation command and the key assignment information in case the predetermined operation command is inputted through the operation inputting section.

4. The AV transmission system as claimed in claim 2, wherein
the operation inputting section is a remote control provided with a plurality of operation keys; and
the remote control is provided with a function menu key that can input the first operation command in one operation, and a plurality of function keys that can input the predetermined operation command in one operation.

5. The AV transmission system as claimed in claim 2, wherein the server device further comprises another AV apparatus that is connected externally.

6. A server device of an AV transmission system that receives data or signal of image and audio from an AV apparatus externally connected, and transfers continuously image data and audio data to a client device according to received data or signal of image and audio, comprising:
a function information obtaining section to obtain function information indicating information of functional performances actuated by external operation from the AV apparatus and a command code to execute the functional performances;
a command sending section to send commands to the AV apparatus externally connected and actuate the functional performances;
a first communication section to conduct data communication with the client device; and
a storing section to store key assignment information which describes an assignment relationship of the functional performances of the AV apparatus and a predetermined operation command from the client device;
wherein information of the functional performances is sent from the server device to the client device through the first communication section; and
in case input information of the predetermined operation command is sent from the client device, one of the commands that actuates one of the functional performances corresponding to the predetermined operation command is sent to the AV apparatus externally connected according to the input information and the key assignment information.

7. The server device as claimed in claim 6, wherein the server device further comprises another AV apparatus that is connected externally.

8. A client device of an AV transmission system that receives image data and audio data from a server device that receives data or signal of image and audio from an AV apparatus externally connected and transfers continuously the image data and the audio data according to received data or signal of image and audio, and demodulates the image data and the audio data into an image signal and an audio signal that can be display outputted and audio outputted, comprising:
an operation inputting section to input an operation command from exterior;
a character display inserting section to insert a signal of a character display in the image signal;
a second communication section to conduct data communication with the server device; and
a storing section to store key assignment information that describes assignment relationship of functional performances and a predetermined operation command which can be inputted from the operation inputting section, according to information of the functional performances actuated by external operation from the AV apparatus sent from the server device;
wherein the key assignment information is outputted within insertion into the image signal by the character inserting section, in case a first operation command is inputted from the operation inputting section; and
input information is sent to the server device in case the predetermined operation command is inputted.

9. The client device as claimed in claim 8, wherein the server device further comprises another AV apparatus that is connected externally.
